(19) United States
(12) Patent Application Publication
(10) Pub. No.: US 2014/0272866 A1
(43) Pub. Date: Sep. 18, 2014

(54) Visual Rendering Engine for Virtual Reality Surgical Training Simulator

(71) Applicant: Peter KIM, Washington, DC (US)

(72) Inventor: Peter KIM, Washington, DC (US)

(21) Appl. No.: 14/063,353

(22) Filed: Oct. 25, 2013

Related U.S. Application Data
(60) Provisional application No. 61/790,573, filed on Mar. 15, 2013.

(51) Int. Cl. G09B 9/00; G06T 19/00

(52) U.S. Cl. CPC G09B 9/00; G06T 19/006
USPC 434/262

(57) ABSTRACT

Exemplary embodiments of a virtual reality surgical training simulator may be described. A virtual reality surgical training simulator may have a rendering engine, a physics engine, a metrics engine, a graphical user interface, and a human machine interface. The rendering engine can display a three-dimensional representation of a surgical site containing visual models of organs and surgical tools located at the surgical site. The physics engine can perform a variety of calculations in real time to represent realistic motions of the tools, organs, and anatomical environment. A graphical user interface can be present to allow a user to control a simulation. Finally, a metrics engine may be present to evaluate user performance and skill based on a variety of parameters that can be tracked during a simulation.

### CROSS REFERENCE TO RELATED APPLICATIONS

This application claims priority from U.S. Provisional Patent Application No. 61/790,573, filed Mar. 15, 2013, and entitled SYSTEM, METHOD, AND COMPUTER PRODUCT FOR VIRTUAL REALITY SURGICAL TRAINING SIMULATOR, the entire contents of which are hereby incorporated by reference.

### BACKGROUND

Simulation is a training technique used in a variety of contexts to show the effects of a particular course of action. Well-known simulators include computer flight simulators used to train pilots or for entertainment and even games like Atari's Battlezone, which was adapted by the U.S. Army to form the basis of an armored vehicle gunnery simulator. Simulators can range from simpler computer-based simulators configured to receive input from a single input device (e.g. a joystick) to complex flight simulators using an actual flight deck or driving simulators having a working steering wheel and a car chassis mounted on a gimbal to simulate the forces experienced while driving a car and the effects of various steering and command inputs provided through the steering wheel.

Surgical simulation platforms exist to allow for teaching and training of a variety of surgical techniques and specific surgical procedures in a safe environment where errors would not lead to life-threatening complications. Typical surgical simulation platforms can be physical devices that are anatomically correct models of an entire human body or a portion of the human body (for example, a chest portion for simulating cardiothoracic surgery or an abdomen portion for simulating digestive system surgery). Further, human analogues for surgical training can come in a variety of sizes to simulate surgery on an adult, child, or baby, and some simulators can be gendered to provide for specialized training for gender-specific surgeries (for example, gynecological surgery, caesarian section births, or orchidectomies/orchiectomies).

While physical surgical platforms are commonly used, physical simulation is not always practical. For example, it is difficult to simulate various complications of surgery with a physical simulation. Further, as incisions are made in physical surgical simulators, physical simulators may require replacement over time and can limit the number of times a physical simulator can be used before potentially expensive replacement parts must be procured and installed.

Virtual reality surgical simulation platforms also are available to teach and train surgeons in a variety of surgical procedures. These platforms are often used to simulate non-invasive surgeries; in particular, a variety of virtual surgical simulation platforms exist for simulating a variety of laparoscopic surgeries. Virtual reality surgical simulators typically include a variety of tools that can be connected to the simulator to provide inputs and allow for a simulation of a surgical procedure.

Virtual reality simulations in three dimensions for virtual reality surgical simulation platforms lack the ability to generate the complex surgical simulation visuals required to train future surgeons to a level of competence and performance that is expected of surgeons today and tomorrow. Further, such three dimensional simulations cannot incorporate new medical technology or medical instruments as they are developed. Such three dimensional simulations do not meet current demands for virtual reality simulations in surgical education.

User interfaces for virtual reality surgical simulation platforms often rely on the use of a keyboard and pointing device to make selections during a surgical simulation. Further, graphical user interfaces for virtual reality surgical simulation platforms often present a multitude of buttons that limit that amount of screen space that can be used to display a simulation. Such interfaces can be unintuitive and require excess time for a user to perform various tasks during a simulation.

### SUMMARY

Exemplary embodiments of a computer-implemented method of providing a virtual reality simulation in three dimensions in conjunction with a virtual reality surgical simulator may be disclosed. The method may include providing an interface to a human-machine interface, a physics engine, a visual rendering engine, and a metrics engine for measuring performance during a simulation. User inputs may be obtained from a variety of input devices in response to prompts or buttons displayed on one or more of the plurality screens presented to a user. User input may be processed to change elements of a graphical user interface displayed to a user, change the state of a virtual reality surgical simulator, or be transmitted to a connected physics engine, rendering engine, and/or metrics engine for processing and feedback. User input may further be processed to display patient-specific information before and during a surgical procedure.

In another aspect, a computer program product having a computer storage medium and a computer program mechanism embedded in the computer storage medium for causing a computer to interface with a graphical user interface system, a metrics engine, a physics engine, and a rendering engine may be disclosed. The computer program mechanism can include a first computer code interface configured to interface with a rendering engine, a second computer code interface configured to interface with a physics engine, and a third computer code interface configured to interface with a metrics engine.

In still another aspect, a system for providing a virtual reality simulation in three dimensions for a virtual reality surgical simulator may be disclosed. The system may include one or more input devices, one or more output devices, a processing system, and one or more transmission systems. The one or more transmission systems can be communicatively coupled to any number of physics engines, rendering engines, and metrics engines. A processing system may be coupled to one or more input devices, one or more output devices, and one or more transmission systems. A processing system may receive an input from one or more input devices, transmit an input to an appropriate connected physics, rendering, or metrics engine through one or more transmission systems, receive an output from one or more connected physics, rendering, or metrics engines through one or more transmission systems, and cause to be displayed on one or more output devices a graphical user interface reflecting a user selection or update as received from one or more input device.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 shows an exemplary flow diagram of a method for initializing, generating, and displaying an initial graphical user interface for a virtual reality surgical simulator to a user.

FIG. 2 shows an exemplary flow diagram of a method for generating and displaying visual representations in a graphical user interface showing the beginning state of a selected simulation to a user of a virtual reality surgical simulator.

FIG. 3 shows an exemplary flow diagram of a method for generating and displaying visual representations in a graphical user interface for a virtual reality surgical simulator showing the status of a connected metrics engine.

FIG. 4 shows an exemplary flow diagram for changing a surgical tool and generating visual representations reflecting said change in a graphical user interface for a virtual reality surgical simulator.

FIG. 5 shows an exemplary flow diagram of a method for generating and displaying visual representations in a graphical user interface for a virtual reality surgical simulator showing user selections of a surgical tool category and tools corresponding to said category.

FIG. 6 shows an exemplary flow diagram of a method for generating and displaying visual representations in a graphical user interface for a virtual reality surgical simulator showing user selection of a tool to be placed in a list of one or more tools available for use during a surgical simulation.

FIG. 7 shows an exemplary flow diagram of a method for generating and displaying visual representations in a graphical user interface for a virtual reality surgical simulator showing user selection of the location of an incision or tool placement in a simulated surgical procedure.

FIG. 8 shows an exemplary flow diagram of a method for generating and displaying visual representations in a graphical user interface for a virtual reality surgical simulator showing a surgical environment in response to a user command to insert a tool into said surgical environment.

FIG. 9 shows an exemplary flow diagram of a method for generating and displaying visual representations in a graphical user interface for a virtual reality surgical simulator showing movement of a tool in a surgical environment corresponding to user commands to move said tool.

FIG. 10 shows an exemplary flow diagram of a method for generating and displaying visual representations in a graphical user interface for a virtual reality surgical simulator showing a surgical environment in response to a user command to remove a tool from said surgical environment.

FIG. 11 shows an exemplary flow diagram of a method for generating and displaying visual representations in a graphical user interface for a virtual reality surgical simulator showing performance metrics and proficiency levels calculated during a surgical simulation.

FIG. 12 shows an exemplary system diagram of a system for providing a graphical user interface for a virtual reality surgical simulator.

FIG. 13 shows an exemplary embodiment of an initial graphical user interface shown at startup containing options for configuring engines connected to a surgical simulator.

FIG. 14 shows an exemplary embodiment of a graphical user interface for a virtual reality surgical simulator showing a surgical location and configured to allow a user to select the location of the placement or surgical tools or incisions.

FIGS. 15a-15b show exemplary embodiments of a graphical user interfaces for selecting any of a plurality of tools available for use in a surgical simulation.

FIG. 16 shows an exemplary embodiment of a graphical user interface for viewing a user's performance in a simulated surgical procedure.

FIG. 17 shows an exemplary system diagram of a system for generating a virtual reality simulation in three dimensions for a virtual reality surgical simulator.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

Generally referring to FIGS. 1-11, methods of generating a user interface for a virtual reality surgical simulator may be disclosed.

FIG. 1 shows an exemplary flow diagram of a method 100 of initializing and displaying an initial user interface for a virtual reality surgical simulator. Method 100 may be a computer-embodied method of delivering an initial graphical user interface for a virtual reality surgical simulator. At command reception step 102, a processing system may receive a command to initiate a virtual reality surgical simulator. A processor at command reception step 102 may be configured to accept a text-based command (e.g. from a terminal window), a selection of an image or button from a mouse input, selection of an image or a button from tactile input, or any other means or method of selection as known in the art. In some embodiments, command reception step 102 may be executed when a system configured to run a virtual reality surgical simulator is started up; in other embodiments, command reception step 102 may require user input.

In response to a command received from step 102, engine initialization step 104 may be executed. In engine initialization step 104, one or more connected engines may be initialized in parallel, in series, or both. In some embodiments, method 100 may cause one or more rendering engines to be initialized on startup and one or more connected physics and metrics engines to be initialized when a surgical simulation is initiated; in other embodiments, method 100 may cause each of the one or more rendering engines, physics engines, and metrics engines connected to a virtual reality surgical simulator to be initiated.

At loading step 106, a processing system may cause a command to be transmitted to one or more connected rendering engines to retrieve description files that are appropriate for composing machine-readable instructions for generating an initial graphical user interface. The files may be at least one of one or more visual object descriptions, visual scene descriptions, physical object descriptions, and physical scene descriptions. In some embodiments, the files used for composing machine-readable instructions for generating an initial graphical user interface may be dynamically generated based on user-desired options. In other embodiments, the layout of an initial graphical user interface may be pre-determined and thus the files used may be pre-determined. The files may be retrievable from a communicatively connected database.

In composing step 108, the processing system may cause the one or more rendering engines to compose machine-readable instructions for generating an initial graphical user interface for a virtual reality surgical simulator. At transmission step 110, the composed set of machine-readable instructions may be transmitted from the one or more rendering engines to one or more processors. In display step 112, a processing system may use the machine-readable instructions generated by composing step 108 to generate and display an initial graphical user interface on a connected visual output device.

FIG. 2 shows an exemplary diagram of a method 200 for initializing a simulation and displaying an initial simulation image on a connected visual output device. In an exemplary embodiment, method 200 may cause a desired simulation to be activated and an initial state of said desired simulation to be displayed on a connected visual output device. A processing system at simulation selection step 202 may receive a user's selection of a desired simulation to be performed. In some embodiments, user selection may be received from a menu or image selection displayed on an initial graphical user interface as rendered and displayed in method 100. In other embodiments, user selection may be received from audio input, textual input, or other selection input as desired and known in the art.

Selection of a desired simulation from simulation step 202 may be transmitted, in step 204, to one or more connected engines. Each of the one or more connected engines may be initialized to display and run the desired simulation. In an embodiment, one or more rendering engines can be initialized to display a variety of tools appropriate for the simulated procedure and one or more images of the surgical environment. One or more metrics engines can be initialized to track performance according to performance metrics specific to a selected procedure. One or more physics engines and one or more rendering engines can be initialized with specific models related to the internal environment of the simulated surgical procedure. For example, selection of a simulation of a lobectomy (laparoscopic lung resection) may cause one or more physics engines to initialize an environment of a thoracic cavity having a lung, heart, and connective tissue within the thoracic cavity, while selection of a cholecystectomy (gallbladder removal) may cause one or more physics engines to initialize an environment of an abdominal cavity having a gallbladder, pancreas, intestines, stomach, and liver. Each of the one or more connected engines initiated in step 204 may transmit a signal to a processing device, in step 206, indicating that each of the one or more connected engines has initiated activation of a selected simulated surgical procedure.

At loading step 208, the processing system may cause a command to be transmitted to one or more connected rendering engines to retrieve the one or more appropriate description files for composing machine-readable instructions for generating one or more initial simulation images. The files may be at least one of one or more visual object descriptions, visual scene descriptions, physical object descriptions, and physical scene descriptions. The files may be retrievable from a communicatively connected database.

In composing step 210, the processing system may cause the one or more rendering engines may compose machine-readable instructions for generating one or more initial simulation images. In some embodiments, composing step 210 may generate machine-readable instructions for a unique image for each individual connected visual output device; in other embodiments, composing step 210 may generate machine-readable instructions for displaying on a single visual output device one or more initial simulation images.

At transmission step 212, the processing system may transmit the machine-readable instructions for generating one or more initial simulation images from the one or more rendering engines to one or more processors and a signal indicating that each of the one or more connected engines is ready to receive input and process a simulated surgical procedure. In display step 214, a processing system may use the machine-readable instructions generated by composing step 210 to generate and display one or more initial simulation images on one or more connected visual output devices.

In some embodiments, method 200 may be configured to load one or more items of patient-specific data for review in addition to initializing a simulation and displaying an initial simulation image on a connected output device. The one or more items of patient-specific data can be images from medical imaging equipment (for example, X-ray radiographs, CT scans, MRI images, or other medical images), textual information (for example, medical charts or textual descriptions of a simulated patient's symptoms), audio information, or any other information as appropriate and desired. In some embodiments, such patient-specific data may be displayed in a central portion of a graphical user interface and hidden when a user begins a simulation. In other embodiments, patient-specific data may be displayed in a graphical user interface on a separate visual output device from the graphical user interface rendered at steps 208 through 212 and displayed on one or more visual output devices at step 214.

FIG. 3 shows an exemplary flow diagram of a method 300 for activating a connected metrics gathering and determination engine. In an exemplary embodiment, method 300 may provide a method of activating or deactivating one or more connected metrics engines and displaying the status of said one or more connected metrics engines on one or more connected visual output devices. At step 302, a processing system may receive a command from a user to activate or deactivate one or more metrics engines. A processing system in step 304 may transmit the appropriate command to each of the one or more desired metrics engines, and each of the one or more desired metrics engines may activate or deactivate and transmit an indication of the state of each of the one or more metrics engines to a processing system. After receiving an indication at step 306 that the one or more desired metrics engines have activated or deactivated, a processing system at status transmission step 308 may transmit the updated status of on ore more metrics engines to one or more connected rendering engines. Next, at composing step 310 one or more connected rendering engines may compose machine-readable instructions for generating and displaying a graphical user interface showing the updated status of one or more connected metrics engines. Then, after composition, the machine-readable instructions for generating and displaying a graphical user interface showing the updated status of one or more connected metrics engines may then be sent to the processing system in step 312. In display step 314, the processing system may use the machine-readable instructions generated by composing step 310 to generate and display a graphical user interface showing the updated status of one or more connected metrics engines on one or more connected visual output devices.

FIG. 4 shows an exemplary flow diagram of a method 400 of generating and displaying one or more visual representations of surgical tools on a virtual tool tray and selecting an instrument for use in a particular location in a simulated surgical environment. An exemplary embodiment of method 400 may generate and display a variety of surgical tools available for use during a simulated procedure in a graphical user interface for a virtual reality surgical simulator. A command to display a virtual tool tray showing a variety of selected surgical tools may be received in step 402. In some embodiments, a user interface may be configured to transmit the command in step 402 when a user hovers over a designated area with a pointing device; in other embodiments, a user interface may be configured to transmit the command in step 402 when a designated area is selected using a pointer selection (e.g. a mouse click or tactile selection on a touchscreen); in still further embodiments, a user interface may be configured to transmit the command in step 402 in response to a vocal input or any other input as desired and known in the art.

In response to the command received in step 402, a processing system may cause a command to be transmitted to one or more connected rendering engines in step 404. Then, at loading step 406, one or more connected rendering engines may be caused to retrieve one or more appropriate description files for composing machine-readable instructions for generating and displaying images of the tools available in a virtual tool tray. The files may be at least one of one or more visual object descriptions, visual scene descriptions, physical object descriptions, and physical scene descriptions. The description files may be retrievable from a communicatively connected database. After loading step 406, in composing step 408, the processing system may cause the one or more rendering engines to compose machine-readable instructions for generating and displaying images of the tools available in a virtual tool tray on one or more visual output devices.

At transmission step 410, the processing system may transmit the machine-readable instructions for generating images of the tools available in a virtual tool tray from the one or more rendering engines to one or more processors. In display step 412, a processing system may use the machine-readable instructions generated by composing step 408 to generate and display images of the tools available in a virtual tool tray on one or more connected visual output devices.

In step 414, a system may receive user selection of a tool from the virtual tool tray displayed in step 412 and a location to use the selected tool. In an embodiment, a user may select a tool and location by selecting a visual representation of a desired tool from the virtual tool tray displayed by step 412 and drop said selection onto a location on a graphical user interface corresponding to a location of a tool placement. The presentation of the virtual tool tray and the drag-and-drop operation for selecting and placing a tool facilitates an intuitive interface for the user, as it provides a close analogy to real-world operations. However, other ways of selecting and placing a tool may be contemplated and provided as desired. For example, using a touch screen, these can include, but are not limited to, pull-down menu lists, scrolling lists, radio buttons, icon arrays, as well as other known selection methods. As another example, without the use of a touch-screen, these can include, but are not limited to, keyboards, pedals, or other motion capture devices.

User input received in step 414 may be transmitted to one or more connected engines in transmission step 416; for example, the selection of a tool may be transmitted to a rendering engine (to be rendered on screen), a physics engine (tools may generate different physical interactions; some may be more or less flexible, or some may be blunt instruments while others may be cutting instruments with sharp edges), and a metrics engine (as input for determining parameters such as the correctness of an instrument choice and location). One or more rendering engines, in step 418, may be caused to retrieve the one or more appropriate description files for composing machine-readable instructions for generating images reflecting the updated selection and location of use of one or more tools within a simulated surgical environment and displaying the images on a graphical user interface. The files may be at least one of one or more visual object descriptions, visual scene descriptions, physical object descriptions, and physical scene descriptions. The description files may be retrievable from a communicatively connected database. After loading step 418, in composing step 420, the processing system may cause the one or more rendering engines to compose machine-readable instructions for generating and displaying images reflecting the updated selection and location of use of one or more tools within a simulated surgical environment. At transmission step 422, the processing system may transmit the machine-readable instructions for generating and displaying images reflecting the updated selection and location of use of one or more tools within a simulated surgical from the one or more rendering engines to one or more processors. In display step 424, a processing system may use the machine-readable instructions generated by composing step 420 to generate and display images of the tools available in a virtual tool tray on one or more connected visual output devices.

FIG. 5 shows an exemplary flow diagram of a method 500 of generating and displaying a variety of surgical tool categories and visual representations of tools in a selected category. A processing system and one or more rendering engines executing method 500 may display one or more categories of tools and one or more visualizations of tools in a selected category of tools on a graphical user interface displayed on one or more connected visual output devices. In step 502, a command to display available tools may be received by a processing system. In some embodiments, a command in step 502 may be generated from user interaction with a pointing device and a graphical user interface, voice input, or any other input as desired and known in the art. At transmission step 504, a processing system may transmit the command received in step 502 to one or more connected rendering engines. In response, at loading step 506, one or more connected rendering engines may be caused to retrieve one or more appropriate description files for composing machine-readable instructions for generating and displaying one or more tool category images to be displayed on a connected device. The files may be at least one of one or more visual object descriptions, visual scene descriptions, physical object descriptions, and physical scene descriptions. The description files may be retrievable from a communicatively connected database. After loading step 506, in composing step 508, the processing system may cause one or more rendering engines to compose machine-readable instructions for generating and displaying one or more tool category images on one or more visual output devices.

At transmission step 510, the processing system may transmit the machine-readable instructions for generating one or more tool category images from the one or more rendering engines to one or more processors. In display step 512, a processing system may use the machine-readable instructions generated by composing step 508 to generate and display one or more tool category images on one or more connected visual output devices.

At step 514, a selection of a tool category from the graphical user interface generated and displayed in display step 512 may be received by a processing system. In response to a selection received in step 514, at step 516, a processing system may transmit the selection to one or more connected rendering engines. Then, at loading step 518, one or more connected rendering engines may be caused to retrieve one or more appropriate description files for composing machine-readable instructions for generating and displaying visual representations of the one or more tools in the selected category on a connected device. The files may be at least one of one or more visual object descriptions, visual scene descriptions, physical object descriptions, and physical scene descriptions. The description files may be retrievable from a communicatively connected database. In step 520, the one or more connected rendering engines may compose a set of machine-readable instructions for generating and displaying visual representations of the one or more tools in a selected category in a graphical user interface on one or more visual output devices.

At transmission step 522, the processing system may transmit the machine-readable instructions for generating and displaying visual representations of the one or more tools in a selected category from the one or more rendering engines to one or more processors. In display step 524, a processing system may use the machine-readable instructions generated by composing step 520 to generate and display visual representations of the one or more tools in a selected category in a graphical user interface on one or more connected visual output devices.

FIG. 6 shows an exemplary flow diagram of a method 600 of adding one or more selected tools to a virtual tool tray and displaying visual representations of one or more selected tools in a selected tool category. Method 600 may build on method 500 and provide a method of storing one or more desired tools in electronic storage for use in a virtual tool tray during a simulated surgical procedure. In selection step 602, one or more selections of desired tools to be stored on a virtual tool tray and made available during a simulated surgical procedure may be received by a processing system. The one or more selections may be transmitted to one or more physics, rendering, and/or metrics engines in step 604. In an embodiment, the one or more selections may be transmitted to one or more rendering engines, which may be configured to generate a set of machine-readable instructions for generating and displaying visual representations of one or more selected tools on a graphical user interface displayed on one or more visual output devices; in another embodiment, the one or more selections may be transmitted to one or more metrics engines, which may be configured to determine the correctness of the tool selections in the context of a selected surgical procedure; however, it may be recognized that the one or more selections may be transmitted to any one or more engines as desired.

At loading step 606, where the one or more selections are transmitted to one or more rendering engines, the one or more connected rendering engines may be caused to retrieve one or more appropriate description files for composing machine-readable instructions for generating and displaying visual representations of the one or more selected tools in a virtual tray on a connected device. The files may be at least one of one or more visual object descriptions, visual scene descriptions, physical object descriptions, and physical scene descriptions. The description files may be retrievable from a communicatively connected database. In composing step 608, the one or more connected rendering engines may generate a set of machine-readable instructions for generating and displaying visual representations of the one or more selected tools in a virtual tray in a graphical user interface on one or more visual output devices. At transmission step 610, the processing system may transmit the machine-readable instructions for generating and displaying visual representations the one or more selected tools in a virtual tray from the one or more rendering engines to one or more processors.

One or more engines may be configured to add the one or more selected tools to a virtual tool tray in step 612. In some embodiments, a processing system at step 612 may be configured to store references to one or more selected tools in non-transitory electronic memory; in other embodiments, a processing system at step 606 may be configured to store references to one or more selected tools in random access memory; however, it may be recognized that one or more selected tools may be stored in any type of electronic memory and in any form as desired and known in the art. In display step 614, a processing system may use the machine-readable instructions generated by composing step 608 to generate and display visual representations of the one or more selected tools in a virtual tray in a graphical user interface on one or more connected visual output devices.

FIG. 7 shows an exemplary flow diagram of a method 700 for generating and displaying visual representations in a graphical user interface reflecting a user selection of an incision or tool placement. In step 702, an input may be received indicating the desired location of an incision or tool placement in a simulated surgical environment. In some embodiments, the input may be coordinates on an X-Y plane; in other embodiments, the input may be a distance from a given point (for example, at full scale, a number of inches/centimeters from the navel); in still further embodiments, the input may be provided from a selection of a location on a previously provided graphical user interface or any other location information as desired. Location information received in step 702 may be transmitted to one or more desired rendering, physics, and metrics engines in step 704. In one embodiment, location information may be transmitted to one or more rendering engines and one or more metrics engines, which may be configured to grade the user-provided input of an incision or tool placement location in comparison to a predetermined optimal incision or tool placement location; however, it may be recognized that the input received in step 702 may be transmitted to any number of connected engines as desired.

In loading step 706, one or more connected rendering engines may be caused to retrieve one or more appropriate description files for composing machine-readable instructions for generating and displaying one or more visual representations reflecting a user selection of an incision or tool placement in a surgical environment on a connected device. The files may be at least one of one or more visual object descriptions, visual scene descriptions, physical object descriptions, and physical scene descriptions. The description files may be retrievable from a communicatively connected database. In step 708, the one or more connected rendering engines may compose a set of machine-readable instructions for generating and displaying one or more visual representations reflecting a user selection of an incision or tool placement in a surgical environment in a graphical user interface on one or more visual output devices. At transmission step 710, the processing system may transmit the machine-readable instructions for generating displaying one or more visual representations reflecting a user selection of an incision or tool placement in a surgical environment from the one or more rendering engines to one or more processors. In display step 712, a processing system may use the machine-readable instructions generated by composing step 708 to generate and display one or more visual representations reflecting a user selection of an incision or tool placement in a surgical environment in a graphical user interface on one or more connected visual output devices.

FIG. 8 shows an exemplary flow diagram of a method 800 for generating and displaying visual representations in a graphical user interface reflecting the insertion of surgical tools into a simulated surgical environment. A system executing method 800 may provide a graphical user interface for a virtual reality surgical simulator, showing one or more images of a surgical environment showing an inserted tool. In step 802, a tool and tool location input may be received. In some embodiments, a tool location may be an X-Y coordinate location indicating the position of a tool (for example, the location of a virtual retractor in invasive surgery); in other embodiments, a tool location may be a relative location (for example, the left, right, or center instrument in a simulated laparoscopic procedure). The location information received in step 802 may be transmitted to one or more connected engines in step 804. In an embodiment, location information may be transmitted to at least one rendering engine, at least one physics engine, which may be configured to calculate the interactions of a selected tool with the surgical environment, and at least one metrics engine, which may be configured to grade the user-provided input of a tool selection and location in comparison to a predetermined optimal tool selection and location.

In loading step 806, one or more connected rendering engines may be caused to retrieve one or more appropriate description files for composing machine-readable instructions for generating and displaying one or more visual representations reflecting the user-prompted insertion of a tool in a surgical environment on a connected device. The files may be at least one of one or more visual object descriptions, visual scene descriptions, physical object descriptions, and physical scene descriptions. The description files may be retrievable from a communicatively connected database. In composing step 808, the one or more connected rendering engines may generate a set of machine-readable instructions for generating and displaying one or more visual representations reflecting the user-prompted insertion of a tool in a surgical environment in a graphical user interface on one or more visual output devices. At transmission step 810, the processing system may transmit the machine-readable instructions for generating and displaying one or more visual reflecting the user-prompted insertion of a tool in a surgical environment from the one or more rendering engines to one or more processors. In display step 812, a processing system may use the machine-readable instructions generated by composing step 808 to generate and display one or more visual representations reflecting the user-prompted insertion of a tool in a surgical environment in a graphical user interface on one or more connected visual output devices.

FIG. 9 shows an exemplary flow diagram of a method 900 for generating and displaying visual representations in a graphical user interface reflecting user-commanded movement of surgical tools within a simulated surgical environment. A system executing method 900 may provide a graphical user interface for a virtual reality surgical simulator showing one or more images of a surgical environment reflecting user-commanded tool movement. A system may receive tool movement input from a user in step 902. Tool movement input received in step 902 may include direction, amount of movement, speed of movement, and/or any other movement information as desired and known in the art. Movement information received in step 902 may be transmitted to one or more connected engines in step 904. In an embodiment, movement information received in step 902 may be transmitted to one or more rendering engines, one or more physics engines, which may be configured to calculate physical interactions of tools and the various soft tissues in a surgical environment, and one or more metrics engines, which may be configured to grade user-input based on the interaction of tools with surrounding tissue, the amount of tissue damage a movement causes, and other metrics as desired.

In loading step 906, one or more connected rendering engines may be caused to retrieve one or more appropriate description files for composing machine-readable instructions for generating and displaying one or more visual representations reflecting the new position of one or more moved tools in a surgical environment and any calculated interactions between tools and tissues in the simulated environment on a connected device. The files may be at least one of one or more visual object descriptions, visual scene descriptions, physical object descriptions, and physical scene descriptions. The description files may be retrievable from a communicatively connected database. In composing step 908, the one or more connected rendering engines may generate a set of machine-readable instructions for generating and displaying one or more visual representations reflecting the new position of one or more moved tools in a surgical environment and any calculated interactions between tools and tissues in the simulated environment in a graphical user interface on one or more visual output devices. At transmission step 910, the processing system may transmit the machine-readable instructions for generating and displaying one or more visual reflecting the user-prompted insertion of a tool in a surgical environment from the one or more rendering engines to one or more processors. In display step 912, a processing system may use the machine-readable instructions generated by composing step 908 to generate and display one or more visual representations reflecting the new position of one or more moved tools in a surgical environment and any calculated interactions between tools and tissues in the simulated environment in a graphical user interface on one or more connected visual output devices.

FIG. 10 shows an exemplary flow diagram of a method 1000 for generating and displaying visual representation in a graphical user interface reflecting the withdrawal of surgical tools from a simulated surgical environment. In step 1002, a command may be received by a processing system to remove one or more tools from a surgical environment. The command received in step 1002 may be transmitted to one or more connected engines in step 1004. In an embodiment, the command received in step 1002 may be transmitted to one or more rendering engines, one or more physics engines, which may be configured to remove references to the one or more tools from the physical environment in which interactions are calculated, and one or more metrics engines, which may be configured to grade the removal of one or more tools based on one or more predetermined guidelines.

In loading step 1006, one or more connected rendering engines may be caused to retrieve one or more appropriate description files for composing machine-readable instructions for generating and displaying one or more visual representations reflecting the withdrawal of one or more tools from a surgical environment on a connected device. The files may be at least one of one or more visual object descriptions, visual scene descriptions, physical object descriptions, and physical scene descriptions. The description files may be retrievable from a communicatively connected database. In composing step 1008, the one or more connected rendering engines may generate a set of machine-readable instructions for generating and displaying one or more visual representations reflecting the withdrawal of one or more tools from a surgical environment in a graphical user interface on one or more visual output devices. At transmission step 1010, the processing system may transmit the machine-readable instructions for generating and displaying one or more visual reflecting the withdrawal of one or more tools from a surgical environment from the one or more rendering engines to one or more processors. In display step 1012, a processing system may use the machine-readable instructions generated by composing step 1008 to generate and display one or more visual representations reflecting the withdrawal of one or more tools from a surgical environment in a graphical user interface on one or more connected visual output devices.

FIG. 11 shows an exemplary flow diagram of a method 1100 for generating a graphical user interface displaying performance metrics gathered during the simulation of a surgical procedure. In step 1102, a command may be received to display performance metrics for one or more simulated procedures. One or more metrics engines may be queried in step 1104 for metrics data relating to the one or more simulated procedures specified by the command received in step 1102. The metrics data received in step 1104 may be transmitted to one or more rendering engines in step 1106.

In loading step 1108, one or more connected rendering engines may be caused to retrieve one or more appropriate description files for composing machine-readable instructions for generating and displaying one or more visual representations showing any number of desired performance parameters and/or indications of a user's proficiency level on a connected device. The files may be at least one of one or more visual object descriptions, visual scene descriptions, physical object descriptions, and physical scene descriptions. The description files may be retrievable from a communicatively connected database. In composing step 1110, the one or more connected rendering engines may generate a set of machine-readable instructions for generating and displaying one or more visual representations showing any number of desired performance parameters and/or indications of a user's proficiency level in a graphical user interface on one or more visual output devices. At transmission step 1112, the processing system may transmit the machine-readable instructions for generating and displaying one or more visual representations showing any number of desired performance parameters and/or indications of a user's proficiency level from the one or more rendering engines to one or more processors. In display step 1114, a processing system may use the machine-readable instructions generated by composing step 1110 to generate and display one or more visual representations showing any number of desired performance parameters and/or indications of a user's proficiency level in a graphical user interface on one or more connected visual output devices.

Turning now to FIG. 12, an exemplary system diagram showing the component parts of a system for providing a user interface for a virtual reality surgical simulator may be disclosed. System 1200 may have at least one input device 1202, at least one output device 1204, a processing system 1206, at least one rendering engine 1208, at least one physics engine 1210, and at least one metrics engine 1212. In some embodiments, at least one input device 1202 and at least one output device 1204 can be combined in a touchscreen monitor, tablet, or other touch-enabled output device. Each of the one or more input devices 1202 and each of the one or more output devices 1204 may be communicatively coupled to a processing system 1206. Processing system 1206 may be configured to receive input from one or more input devices 1202 and transmit the input to one or more rendering engines 1208, one or more physics engines 1210, and one or more metrics engines 1212. One or more physics engines 1210 and metrics engines 1212 can be communicatively coupled to one or more rendering engines 1208; in some embodiments; physics engines 1210 and metrics engines 1212 can be communicatively coupled to one or more rendering engines 1208 through processing system 1206; in other embodiments, physics engines 1210 and metrics engines 1212 can be communicatively coupled directly to one or more rendering engines 1208. In response to user input provided through one or more input devices 1202, processing system 1206 may transmit input to one or more connected engines 1208, 1210, and 1212. During a simulation, one or more rendering engines 1208 may receive input from one or more input devices 1202 and one or more physics engines 1210. In response to said inputs from one or more input devices 1202 and one or more physics engines 1210, one or more rendering engines 1208 may generate a set of machine-readable instructions for generating a visual output of a graphical user interface containing a selected view of a simulated surgery. The set of machine-readable instructions generated by one or more rendering engines 1208 may be transmitted to processing system 1206, which may cause a visual output of a graphical user interface containing a selected view of a simulated surgery to be displayed on one or more visual output devices 1204.

The one or more rendering engines 1208 may generate a graphical user interface on one or more visual output devices. In a system state where a simulation is not being performed or where a user is selecting one or more tools for use during a simulation, one or more rendering engines may render a variety of pages for configuring a simulator, various engines connected to the simulation system, input and output devices, and other configurations as desired. When a simulation is running, one or more rendering engines may generate a graphical user interface displaying in real-time three-dimensional models of the surgical environment reflecting tool movement, tissue movement, and changes in various tissues during surgery. For example, in a segmental resection of an organ, one or more rendering engines can show a portion of an organ being removed, while in a procedure requiring the total removal of soft tissue, one or more rendering engines can show in real-time an updated surgical environment absent the removed soft tissue. The one or more rendering engines 1208 may interact with one or more physics engines 1210 to further determine the visual behavior of the surgical environment to be displayed in real time. In an embodiment, one or more visual rendering engines may be partially based on the Object-Oriented Graphics Rendering Engine and operate in a DirectX or OpenGL abstracted environment; however, the visual rendering engines may be based on any desired rendering engine with the capability of rendering scenes in real-time based on three-dimensional models and outputs from one or more physics engines. In some embodiments, visual three-dimensional models of tools, soft tissue, and the surgical environment may be implemented using a mesh file that may be interpreted by one or more rendering engines to be displayed on one or more visual output devices.

The one or more physics engines 1210 may be communicatively coupled to one or more rendering engines to generate interaction calculations between objects in the surgical environment that may be rendered by one or more rendering engines and displayed on one or more visual output devices. One or more physics engines 1210 may perform in real time interaction calculations including kinematics, collision, and deformation calculations to represent realistic motions of tools, organs, and the anatomical environment. The interaction calculations generated by one or more physics engines 1210 may be transmitted to one or more rendering engines to cause to be displayed on one or more visual output devices an updated surgical environment showing the interactions calculated by one or more physics engines. In some embodiments, the one or more physics engines 1210 can be based on the Simulation Open Framework Architecture, and each tool, soft tissue, and surgical environment can have a geometric model and a visual model. The geometric model of an object can be a mechanical model having a mass and constitutive laws; for example, a rigid metal tool can have the mass of the real-life version of the tool and can be configured to require a large amount of force to cause a deflection, while a soft tissue can have the mass of a typical soft tissue being simulated and can be configured to require a small amount of force to cause a deflection, rupturing, or other deformation. The visual model of an object can have a more detailed geometry and rendering parameters that can be dynamically modified during a simulation to show the effects of a course of action on the size and character of each object.

The one or more metrics engines 1212 may be configured to evaluate a user's performance and skill in performing a surgical procedure based on user input. One or metrics engines 1212 may be communicatively coupled to one or more rendering engines and one or more physics engines and may receive input from one or more input devices. The performance metrics calculated by the one or more metrics engines 1212 may be tailored to monitor specific inputs depending on the surgical simulation; for example, a simulated invasive surgery could be configured to monitor incision placement rather than laparoscopic tool placement, while a simulated laparoscopic surgery could be configured to monitor tool placement rather than the location of an incision. In an embodiment, each simulated surgical procedure can have one or more metrics engine configuration files specifying the data to be collected and the parameters a user may be graded on. In some embodiments, metrics may be calculated from interaction calculations generated by one or more physics engines (e.g. when tools impact soft tissue); in other embodiments, metrics may be calculated from one or more rendering engines (e.g. when a tool leaves the viewing area in a laparoscopic procedure, or the position of various tools throughout the simulated procedure); in still further embodiments, metrics may be calculated from a combination of interaction calculations generated by one or more physics engines and one or more rendering engines. In an embodiment, one or metrics engines 1212 may be configured to assign a numerical value to each action and interaction of tools and soft tissue, and the accumulated numerical value may be used to determine an overall score for the simulation and the user's proficiency in any number of criteria to be monitored.

System 1200 may further be configured to display metrics and statistics generated during simulation of a surgical procedure. Processing system 1206 may be configured to receive a user input requesting the display of performance metrics. In response to such a command, processing system 1206 may query one or more connected metrics engines 1212 for performance metrics information and transmit that data to one or more rendering engines 1208. The one or more rendering engines 1208 may transform the raw performance metrics data into a set of machine-readable instructions for generating a visual output of a graphical user interface configured to display performance data. The set of machine-readable instructions generated by the one or more rendering engines 1208 from data received from one or more metrics engines 1212 may be transmitted to processing system 1206, which may cause metrics data to be displayed on one or more visual output devices 1204 in accordance with machine-readable instructions generated by the one or more rendering engines 1208.

Generally referring to FIGS. 13-16, a graphical user interface for a virtual reality surgical simulator may be disclosed. Graphical user interface 1300 may be configured to present information in an easy-to-use manner and enable a user to access configuration options and tools in a natural and intuitive manner before and during a simulated surgical procedure. Graphical user interface 1300 may allow a user to initiate a variety of surgical simulations, change information about the hardware configuration connected to a system running the virtual reality surgical simulation software, and view and modify the data gathering and metric calculation functionality of the surgical simulation software. In an embodiment, graphical user interface 1300 may have a plurality of options and areas configured to display secondary information, such as simulator navigation, simulator status, and input device status information in the periphery of a main panel 1302. Main panel 1302 may be configured to display a plurality of icons representing various configuration options. When a surgical simulation is running, graphical user display 1300 may have a main panel 1302 configured to display a variety of content, including menus and visualizations of a simulation generated by a connected rendering engine and physics engine. In some embodiments, graphical user interface 1300 may be configured to be displayed on a touchscreen such that elements displayed on graphical user interface 1300 may be selected by tapping on a desired element or location on a screen. Buttons generated for display on a graphical user interface configured to be displayed on a touchscreen may be sized sufficiently to allow a user to easily view and select a button from any desired distance away from a visual output device. In still further embodiments, graphical user interface 1300 may be split between multiple screens, at least one of which can be configured to show one or more visualizations of an internal surgical environment and at least one of which can be configured to show one or more visualizations of an external surgical environment. In an embodiment having a graphical user display split between multiple screens, secondary information may be displayed on one or more individual visual output devices; in other embodiments, secondary information may be displayed on a periphery of one or more visual output devices having a main panel configured to display one or more visualizations of a surgical environment.

Referring specifically to FIG. 13, an exemplary embodiment of a graphical user interface generated by a connected rendering engine and physics engine for configuring a virtual reality surgical simulator may be disclosed. Panel 1302 of graphical user interface 1300 may have a plurality of menus, generally designated 1304, for configuring various parts of the surgical simulator. In an exemplary embodiment, menu 1304a may be configured to begin and end a surgical simulation. Menu 1304b may be configured to allow a user to modify the hardware configuration and associate different input devices with different surgical tools that may be used in a particular procedure. Menu 1304c may be configured to allow a user to begin and end data gathering and metrics calculation for users performing a simulated surgical procedure using graphical user interface 1300. It may be recognized that any number of desired menus 1304 may be displayed in panel 1302. In further embodiments, a camera selection 1306 may be displayed to a user to allow the selection of any desired camera from a set of one or more cameras connected to a virtual reality surgical simulator system. Embodiments of a graphical user interface may further have a camera mode toggle 1308. Camera mode toggle 1308 may be configured to allow a user to change whether a camera is free to move or is slaved to another device. Still further, embodiments of a graphical user interface may have a head-mounted display toggle 1310 to allow a user to change the view displayed on a connected head-mounted display.

Referring now to FIG. 14, an exemplary embodiment of a graphical user interface generated by a connected rendering engine and physics engine for determining the location of the placement of surgical tools or incisions may be disclosed. Graphical user interface 1400 may have an expandable tool selection panel 1402 containing visual representations of one or more of the surgical tools 1404 available in any given simulation. Visualization panel 1302 may display an image of a surgical location. Panel 1302 may be configured to receive selection inputs from a user to determine the location of incisions and tool placements at the surgical location displayed in panel 1302. Tool status indicators 1406 may show whether a tool is inserted into the simulated patient or not. In an exemplary embodiment, the location of incisions or placements of surgical tools may be selected on a touchscreen by tapping on a desired location on visualization panel 1302.

Referring now to FIG. 15, an exemplary embodiment of a graphical user interface generated by a connected rendering engine and physics engine for selecting a variety of tools for use in a surgical simulation may be disclosed. FIG. 15a may disclose a category selection page displayed on the graphical user interface. Panel 1302 may display one or more tool categories 1502. In some embodiments, the one or more tool categories 1502 may be displayed in a grid; in other embodiments, the one or more tool categories 1502 may be displayed in a rotating carousel; still further, the one or more tool categories 1502 may be displayed in a scrollable list or any other display arrangement as desired and known in the art. When a tool category 1502 is selected, panel 1302 may display one or more tool visualizations 1504, as shown in FIG. 15b. In some embodiments, the one or more tool visualizations 1504 may be displayed in a grid; in other embodiments, the one or more tool visualizations 1504 may be displayed in a rotating carousel; still further, the one or more tool visualizations 1504 may be displayed in a scrollable list or any other display arrangement as desired and known in the art. Each of the one or more tool visualizations 1504 may contain an image of the tool and a textual description of the tool. Each of the one or more tool visualizations 1504 may be selected by a user in relation to a tool status indicator 1406. In some embodiments, a tool visualization 1504 may be dragged to a tool status indicator 1406, at which point tool status indicator 1406 may display an image associated with tool visualization 304.

Referring now to FIG. 16, an exemplary embodiment of a graphical user interface generated by a connected rendering engine and physics engine for viewing a user's performance in a simulated surgical procedure may be disclosed. At least one parameters panel 1602 may be displayed on graphical user interface 1600. A data panel 1604 may be displayed and may be configured to show the name of a user, the name of the simulation for which metrics may be displayed, a session ID, a calculated score, and any other information as appropriate and desired. In some embodiments, a displayed session ID may be an alphanumeric string; in other embodiments, a displayed session ID may be a date/time stamp or any other identifier as desired. A parameter panel 1602 may be configured to show data related to a desired parameter, such as efficiency, dexterity, or any other parameter to be graded during a simulation. For example, in an exemplary embodiment where metrics are displayed for a simulated laparoscopic procedure, parameters can include the amount of time and motion expended during a simulation, comparisons of the user's resection to an optimal resection, amount of force imparted during the simulation, the amount of tissue damage, number of times an instrument went out of view, and comparisons of tool placement and instrument selection to an optimal placement and selection. In an exemplary embodiment, parameter panel 1602 may have one or more parameter data panels 1606, which may contain the name of a sub-parameter, a visual representation of a user's performance as compared to a perfect or optimal performance, and an indication of a user's skill level for the displayed sub-parameter.

Turning now to FIG. 17, an exemplary system diagram showing the component parts of a system for providing virtual reality simulations in three dimensions for a virtual reality surgical simulator may be disclosed. System 1700 may have at least one input device 1202, at least one output device 1204, a processing system 1206, at least one rendering engine 1208, at least one physics engine 1210, and at least one metrics engine 1212. In some embodiments, at least one input device 1202 and at least one output device 1204 can be combined in a touchscreen monitor, tablet, or other touch-enabled output device. Each of the one or more input devices 1202 and each of the one or more output devices 1204 may be communicatively coupled to a processing system 1206. Processing system 1206 may be configured to receive input from one or more input devices 1202 and transmit the input to one or more rendering engines 1208, one or more physics engines 1210, and one or more metrics engines 1212. One or more physics engines 1210 and metrics engines 1212 can be communicatively coupled to one or more rendering engines 1208; in some embodiments; physics engines 1210 and metrics engines 1212 can be communicatively coupled to one or more rendering engines 1208 through processing system 1206; in other embodiments, physics engines 1210 and metrics engines 1212 can be communicatively coupled directly to one or more rendering engines 1208. In response to user input provided through one or more input devices 1202, processing system 1206 may transmit input to one or more connected engines 1208, 1210, and 1212. During a simulation, one or more rendering engines 1208 may receive input from one or more input devices 1202 and one or more physics engines 1210. In response to said inputs from one or more input devices 1202 and one or more physics engines 1210, one or more rendering engines 1208 may generate a set of machine-readable instructions for generating a visual output of a graphical user interface containing a selected view of a simulated surgery. The set of machine-readable instructions generated by one or more rendering engines 1208 may be transmitted to processing system 1206, which may cause a visual output of a graphical user interface containing a selected view of a simulated surgery to be displayed on one or more visual output devices 1204.

The one or more rendering engines 1208 may generate machine readable instructions to render a graphical user interface on one or more visual output devices. In a system state where a simulation is not being performed or where a user is selecting one or more tools for use during a simulation, one or more rendering engines 1208 may generate machine readable instructions to render a variety of pages for configuring a simulator, various engines connected to the simulation system, input and output devices, and other configurations as desired. When a simulation is running, one or more rendering engines may generate machine readable instructions to render a graphical user interface displaying in real-time three-dimensional models of the surgical environment reflecting tool movement, tissue movement, and changes in various tissues during surgery. For example, in a segmental resection of an organ, one or more rendering engines can generate machine readable instructions to show a portion of an organ being removed, while in a procedure requiring the total removal of soft tissue, one or more rendering engines can generate machine readable instructions to show in real-time an updated surgical environment absent the removed soft tissue. The one or more rendering engines 1208 may interact with one or more physics engines 1210 to further determine the visual behavior of the surgical environment to be displayed in real time. In an embodiment, one or more visual rendering engines 1208 may be partially based on the Object-Oriented Graphics Rendering Engine and operate in a DirectX or OpenGL abstracted environment; however, the visual rendering engines may be based on any desired rendering engine 1208 with the capability of rendering scenes in real-time based on three-dimensional models and outputs from one or more physics engines 1210.

Visual rendering engine 1208 may be coupled to a physics engine 1210 to display a virtual reality surgical simulation in real-time. Calculations, physical object descriptions 1702, and physical scene descriptions 1704 from a physics engine 1210 may be transmitted to visual rendering engine 1208. In some embodiments, one or more physical object 1702 descriptions and one or more physical scene descriptions 1704 may be stored in database 1710, and the appropriate physical scene description 1704 and the one or more visual object descriptions 1702 may be loaded into visual rendering engine 1208 depending on the surgical simulation being performed. Visual rendering engine 1208 can output machine readable instructions to generate visualizations in real-time reflecting deformations, collisions, and movements of tools and soft tissue as a surgical procedure is simulated. Rendering engine 1208 can further reflect speed at which tools can be moved and use the output from a physics engine 1210 to reflect the deceleration of a tool as it collides or cuts through soft tissue.

Rendering engine 1208 may generate machine readable instructions to generate a view of a simulated surgical site based on one or more visual scene descriptions 1706 and one or more visual object descriptions 1708. In an exemplary embodiment, visual scene descriptions 1706 can provide a complete description of the visual environment to be rendered and displayed by rendering engine 1208 and can be customized to have any desired number of elements.

Visual scene descriptions 1706 and visual object descriptions 1708 may represent three-dimensional models of surgical environments, surgical sites, surgical instruments, soft tissue, organs, and other items as desired. In some embodiments, one or more visual scene descriptions 1706 and one or more visual object descriptions 1708 may be stored in a database 1710, and the appropriate visual scene description 1706 and one or more visual object descriptions 1708 may be loaded into visual rendering engine 1208 depending on the surgical simulation to be performed.

In an embodiment, visual scene descriptions 1706 may be ASCII-formatted text files that contain a textual description of all the visual objects in the scene, such as the surgical environment, the patient and all available surgical instruments. Visual scene descriptions 1706 can make references to any of the one or more visual object descriptions 1708.

In some embodiments, the one or more visual object descriptions 1708 can describe visual objects. These visual object descriptions 1708 may include files containing binary descriptions of the objects that allow the visual rendering engine 1208 to display visualizations on one or more visual output devices 1204. A file may be a mesh file, such as an Object-Oriented Graphics Rendering Engine (OGRE) visual mesh file, that contains a surface mesh that delineates a purely visual object. A file can contain geometry, topology, texture coordinate, and texture name information. A file can include all of the definitions required to generate instructions for a tissue visual body, i.e., a visual representation of a patient and patient organs. A file can also include all of the definitions required to generate instructions for a tissue contact body, i.e., visual representations of simulated surgical procedures. The geometric primitive of a file may be polygonal, for example the geometric primitive may be triangular with three vertices or quadrangular with four vertices. Visual object descriptions 1708 may include two files that define the border of tissue and the connections between the tissue border and neighbor organs. Additionally, visual object descriptions 1708 may include files for texture from which machine-readable instructions for which a three layer texture tissue visual effect can be derived by the rendering engine 1208.

Additionally, in some embodiments, the one or more visual object descriptions 1708 can also describe objects having a corresponding physical object description 1702. These visual object descriptions 1708 may be files containing binary descriptions of the objects that allow the visual rendering engine 1208 to display visualizations on one or more visual output devices 1204. A file may be a mesh file, such as a Simulation Open Framework Architecture (SOFA) visual mesh file, that contains a surface mesh that delineates an object that also has an associated physical mesh. In some embodiments, the rendering engine 1208 can use SOFA visual mesh files to compose machine readable instructions to generate visual simulations that reflect the physical behavior of the interaction of tissues, organs, and instruments during deformations, collisions, and movements of a simulated surgical procedure. Furthermore, to model tissue incisions or cuts, the visual and physical meshes can be modified during the rendering process. The meshes can be modified via an L-3 developed software interface layer that identifies the parts of the mesh that are affected by the surgical procedure and that directly modifies the underlying mesh structure itself.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of generating a virtual reality simulation in three dimensions for a virtual reality surgical simulator, comprising:
receiving a command to initialize a simulation;
initializing a connection to one or more connected rendering, physics, and metrics engines;
loading into the one or more connected rendering engines at least one initial state description file that is appropriate to render an initial state of a graphical user interface, wherein the graphical user interface is configured to provide an interface having secondary information in a periphery of the graphical user interface and a configurable main panel in a central area of the graphical user interface;
composing a first set of machine-readable instructions for generating the initial state of the graphical user interface by the one or more connected rendering engines;
transmitting the first set of machine-readable instructions to a processing system; and
causing the initial state of the graphical user interface to be displayed on at least one connected output device having a plurality of configuration option icons displayed in the main panel configured to allow a user to change the configuration or state of a virtual reality surgical simulator system on selection of one or more icons.

2. The method of claim 1, further comprising:
receiving a selection of a desired simulation;
transmitting information to the one or more connected engines to initialize the desired simulation;
loading into the one or more connected rendering engines at least one initial simulation description file as is appropriate to render one or more initial simulation images;
composing a second set of machine-readable instructions for generating one or more initial simulation images by the one or more connected rendering engines;
transmitting the second set of machine-readable instructions to the processing system; and
causing the one or more initial simulation images to be displayed in the main panel on the one or more connected output devices.

3. The method of claim 2, further comprising:
causing the one or more connected rendering engines to access one or more items of patient-specific data;
causing the one or more items of patient specific data to be displayed on the one or more connected output devices.

4. The method of claim 2, further comprising:
receiving a command to activate one or more connected engines;
causing to be activated the one or more connected engines; and
transmitting the status of the one or more activated connected engines to the one or more connected rendering engines;
composing a third set of machine-readable instructions for generating one or more activated connected engine status images by the one or more connected rendering engines;
transmitting the third set of machine-readable instructions to the processing system; and
causing the one or more activated connected engine status images to be displayed in the periphery of the graphical user interface on the one or more connected output devices.

5. The method of claim 2, further comprising:
receiving a command to display a set of available tools and a virtual tool tray;
transmitting the command to display the set of available tools the virtual tool tray to the one or more connected rendering engines;
loading into the one or more connected rendering engines at least one tool description file that is appropriate to render one or more available tool images;
composing a fourth set of machine-readable instructions for generating the one or more available tool images;
transmitting the fourth set of machine-readable instructions to the processing system;
causing the one or more available tool images to be displayed in the main panel on at least one of the connected output devices.

6. The method of claim 5, further comprising:
receiving a command to select and locate one or more the available tools;
transmitting the command to select and locate one or more the available tools to the one or more connected rendering engines;
loading into the one or more connected rendering engines at least one selection and location description file that is appropriate to render one or more visual representations reflecting the selection and location of the one or more available tools;
composing a fifth set of machine-readable instructions for generating the one or more visual representations reflecting the selection and location of the one or more available tools;
transmitting the fifth set of machine-readable instructions to the processing system;
causing the one or more visual representations reflecting the selection and location of the one or more available tools to be displayed in the main panel on at least one of the connected output devices.

7. The method of claim 2, further comprising:
receiving a command to display a set of available tool categories;
transmitting the command to display the set of available tool categories to the one or more connected rendering engines;
loading into the one or more connected rendering engines at least one tool category description file that is appropriate to render one or more available tool category images;
composing a sixth set of machine-readable instructions for generating the one or more available tool category images;
transmitting the sixth set of machine-readable instructions to the processing system; and
causing the one or more available tool category images to be displayed in the main panel on at least one of the connected output devices.

8. The method of claim 7, further comprising:
receiving a command to select one or more available tool categories;
transmitting the command to select one or more available tool categories to the one or more connected rendering engines;
loading into the one or more connected rendering engines at least one tool description file that is appropriate to render one or more visual representations of one or more tools in the selected tool category;
composing a seventh set of machine-readable instructions for generating the one or more visual representations of the one or more tools in the selected tool category;
transmitting the seventh set of machine-readable instructions to the processing system; and
causing one or more visual representations of the one or more tools in the selected tool category to be displayed in a main panel on a connected output device.

9. The method of claim 2, further comprising:
receiving a command to select one or more of desired tools;
transmitting the command to select one or more desired tools to the one or more connected rendering engines;
loading into the one or more connected rendering engines at least one desired tool description file that is appropriate to render one or more visual representations reflecting the one or more desired tools in a virtual tool tray;
composing an eighth set of machine-readable instructions for generating the one or more visual representations reflecting one or more desired tools in the virtual tool tray;
transmitting the eighth set of machine-readable instructions to the processing system; and
causing the one or more visual representations reflecting one or more desired tools in the visual tray to be displayed in the main panel on at least one of the connected output devices.

10. The method of claim 2, further comprising:
receiving input indicating a desired location of an incision or a tool placement in a simulated surgical environment;
transmitting location information to one or more connected engines;
loading into the one or more connected rendering engines at least one incision or a tool placement description file that is appropriate to render one or more visual representations reflecting the incision or the tool placement in the simulated surgical environment;
composing a ninth set of machine-readable instructions for generating the one or more visual representations reflecting the incision or the tool placement in the simulated surgical environment;
transmitting the ninth set of machine-readable instructions to the processing system; and
causing to be displayed in a main panel on a connected output device an updated simulation image showing the incision or the tool placement at the desired location in the simulated surgical environment.

11. The method of claim 2, further comprising:
receiving tool movement input from a user;
transmitting said movement input to one or more connected engines;
loading into the one or more connected rendering engines at least one movement description file that is appropriate to render one or more visual representations reflecting a new tool location and a new calculated surgical environment;
composing a tenth set of machine-readable instructions for generating the one or more visual representations reflecting the new tool location and the new calculated surgical environment;
transmitting the tenth set of machine-readable instructions to the processing system; and
causing to be displayed in a main panel on a connected output device an updated simulation image showing updated tool locations and an updated surgical environment.

12. The method of claim 2, further comprising:
receiving a command to remove a tool from a surgical environment;
transmitting said command to one or more connected engines;
loading into the one or more connected rendering engines at least one removal description file that is appropriate to render one or more visual representations reflecting a tool removed from a surgical environment;
composing a eleventh set of machine-readable instructions for generating the one or more visual representations reflecting the tool removed from the surgical environment;
transmitting the eleventh set of machine-readable instructions to the processing system; and
causing to be displayed in a main panel on a connected output device an updated simulation image showing a selected tool removed from a surgical environment.

13. The method of claim 2, further comprising:
receiving a command to display metrics generated during a simulation;
querying a connected metrics engine for metrics data;
generating machine-readable instructions for displaying queried metrics data;
transmitting machine-readable instructions containing queried metrics data to a connected rendering engine;
loading into the one or more connected rendering engines at least one metrics data description file that is appropriate to render one or more visual representations reflecting the queried metrics data;
composing a twelfth set of machine-readable instructions for generating the one or more visual representations reflecting the queried metrics data;
transmitting the twelfth set of machine-readable instructions to the processing system; and
causing to be displayed in a main panel on a connected output device a graphical user interface showing the queried metrics data.

14. A system for providing a virtual reality simulation in three dimensions for a virtual reality surgical simulator, comprising:
a processing system, configured for generating and displaying visual representations of a simulated surgical environment in a graphical user interface configured to present at least one simulation image in at least one central portion of the graphical user interface and secondary information in at least one periphery of the graphical user interface;
at least one input device communicatively coupled to the processing system;
at least one output device communicatively coupled to the processing system;
at least one rendering engine communicatively coupled to the processing system and configured to compose sets of machine-readable instructions for generating and displaying the visual representations;
at least one physics engine communicatively coupled to the processing system; and
at least one metrics engine communicatively coupled to the processing system,
at least one database communicatively coupled to a the processing system.

15. The system of claim 14, where in the sets of machine-readable instructions are based on at least one visual scene description.

16. The system of claim 15, wherein the at least one visual scene description references at least one visual object description.

17. The system of claim 15, wherein the at least one visual object description is a mesh file.

18. The system of claim 15, wherein the at least one visual scene description references at least one physical scene description.

19. The system of claim 15, wherein the at least one visual scene description references at least one physical object description.

20. A non-transitory computer readable medium storing a set of computer readable instructions that, when executed by one or more processors, causes a device to perform a process comprising:
receiving a command to initialize a simulation;
initializing a connection to one or more connected rendering, physics, and metrics engines;
loading into the one or more connected rendering engines at least one initial state description file that is appropriate to render an initial state of a graphical user interface, wherein the graphical user interface is configured to provide an interface having secondary information in a periphery of the graphical user interface and a configurable main panel in a central area of the graphical user interface;
composing a first set of machine-readable instructions for generating the initial state of the graphical user interface by the one or more connected rendering engines;
transmitting the first set of machine-readable instructions to a processing system; and
causing the initial state of the graphical user interface to be displayed on at least one connected output device having a plurality of configuration option icons displayed in the main panel configured to allow a user to change the configuration or state of a virtual reality surgical simulator system on selection of one or more icons.

21. The non-transitory computer readable medium of claim 20, the process further comprising:
receiving a selection of a desired simulation;
transmitting information to the one or more connected engines to initialize the desired simulation;
loading into the one or more connected rendering engines at least one initial simulation description file as is appropriate to render one or more initial simulation images;
composing a second set of machine-readable instructions for generating one or more initial simulation images by the one or more connected rendering engines;
transmitting the second set of machine-readable instructions to the processing system; and
causing the one or more initial simulation images to be displayed in the main panel on the one or more connected output devices.

22. The non-transitory computer readable medium of claim 20, the process further comprising:
causing the one or more connected rendering engines to access one or more items of patient-specific data;
causing the one or more items of patient specific data to be displayed on the one or more connected output devices.

23. The non-transitory computer readable medium of claim 20, the process further comprising:
receiving a command to activate one or more connected engines;
causing to be activated the one or more connected engines; and
transmitting the status of the one or more activated connected engines to the one or more connected rendering engines;
composing a third set of machine-readable instructions for generating one or more activated connected engine status images by the one or more connected rendering engines;
transmitting the third set of machine-readable instructions to the processing system; and
causing the one or more activated connected engine status images to be displayed in the periphery of the graphical user interface on the one or more connected output devices.

24. The non-transitory computer readable medium of claim 20, the process further comprising:
receiving a command to display a set of available tools and a virtual tool tray;
transmitting the command to display the set of available tools the virtual tool tray to the one or more connected rendering engines;
loading into the one or more connected rendering engines at least one tool description file that is appropriate to render one or more available tool images;
composing a fourth set of machine-readable instructions for generating the one or more available tool images;
transmitting the fourth set of machine-readable instructions to the processing system;
causing the one or more available tool images to be displayed in the main panel on at least one of the connected output devices.

25. The non-transitory computer readable medium of claim 24, the process further comprising:
receiving a command to select and locate one or more the available tools;
transmitting the command to select and locate one or more the available tools to the one or more connected rendering engines;
loading into the one or more connected rendering engines at least one selection and location description file that is appropriate to render one or more visual representations reflecting the selection and location of the one or more available tools;
composing a fifth set of machine-readable instructions for generating the one or more visual representations reflecting the selection and location of the one or more available tools;
transmitting the fifth set of machine-readable instructions to the processing system;
causing the one or more visual representations reflecting the selection and location of the one or more available tools to be displayed in the main panel on at least one of the connected output devices.

26. The non-transitory computer readable medium of claim 20, the process further comprising:
receiving a command to display a set of available tool categories;
transmitting the command to display the set of available tool categories to the one or more connected rendering engines;
loading into the one or more connected rendering engines at least one tool category description file that is appropriate to render one or more available tool category images;
composing a sixth set of machine-readable instructions for generating the one or more available tool category images;
transmitting the sixth set of machine-readable instructions to the processing system; and
causing the one or more available tool category images to be displayed in the main panel on at least one of the connected output devices.

27. The non-transitory computer readable medium of claim 26, the process further comprising:
receiving a command to select one or more available tool categories;
transmitting the command to select one or more available tool categories to the one or more connected rendering engines;
loading into the one or more connected rendering engines at least one tool description file that is appropriate to render one or more visual representations of one or more tools in the selected tool category;
composing a seventh set of machine-readable instructions for generating the one or more visual representations of the one or more tools in the selected tool category;
transmitting the seventh set of machine-readable instructions to the processing system; and
causing one or more visual representations of the one or more tools in the selected tool category to be displayed in a main panel on a connected output device.

28. The non-transitory computer readable medium of claim 20, the process further comprising:
receiving a command to select one or more of desired tools;
transmitting the command to select one or more desired tools to the one or more connected rendering engines;
loading into the one or more connected rendering engines at least one desired tool description file that is appropriate to render one or more visual representations reflecting the one or more desired tools in a virtual tool tray;
composing an eighth set of machine-readable instructions for generating the one or more visual representations reflecting one or more desired tools in the virtual tool tray;
transmitting the eighth set of machine-readable instructions to the processing system; and
causing the one or more visual representations reflecting one or more desired tools in the visual tray to be displayed in the main panel on at least one of the connected output devices.

29. The non-transitory computer readable medium of claim 20, the process further comprising:
receiving input indicating a desired location of an incision or a tool placement in a simulated surgical environment;
transmitting location information to one or more connected engines;
loading into the one or more connected rendering engines at least one incision or a tool placement description file that is appropriate to render one or more visual representations reflecting the incision or the tool placement in the simulated surgical environment;
composing a ninth set of machine-readable instructions for generating the one or more visual representations reflecting the incision or the tool placement in the simulated surgical environment;
transmitting the ninth set of machine-readable instructions to the processing system; and
causing to be displayed in a main panel on a connected output device an updated simulation image showing the incision or the tool placement at the desired location in the simulated surgical environment.

30. The non-transitory computer readable medium of claim 20, the process further comprising:
receiving tool movement input from a user;
transmitting said movement input to one or more connected engines;
loading into the one or more connected rendering engines at least one movement description file that is appropriate to render one or more visual representations reflecting a new tool location and a new calculated surgical environment;
composing a tenth set of machine-readable instructions for generating the one or more visual representations reflecting the new tool location and the new calculated surgical environment;
transmitting the tenth set of machine-readable instructions to the processing system; and
causing to be displayed in a main panel on a connected output device an updated simulation image showing updated tool locations and an updated surgical environment.

31. The non-transitory computer readable medium of claim 20, the process further comprising:
receiving a command to remove a tool from a surgical environment;
transmitting said command to one or more connected engines;
loading into the one or more connected rendering engines at least one removal description file that is appropriate to render one or more visual representations reflecting a tool removed from a surgical environment;
composing a eleventh set of machine-readable instructions for generating the one or more visual representations reflecting the tool removed from the surgical environment;
transmitting the eleventh set of machine-readable instructions to the processing system; and
causing to be displayed in a main panel on a connected output device an updated simulation image showing a selected tool removed from a surgical environment.

32. The non-transitory computer readable medium of claim 20, the process further comprising:
receiving a command to display metrics generated during a simulation;
querying a connected metrics engine for metrics data;
generating machine-readable instructions for displaying queried metrics data;
transmitting machine-readable instructions containing queried metrics data to a connected rendering engine;
loading into the one or more connected rendering engines at least one metrics data description file that is appropriate to render one or more visual representations reflecting the queried metrics data;
composing a twelfth set of machine-readable instructions for generating the one or more visual representations reflecting the queried metrics data;
transmitting the twelfth set of machine-readable instructions to the processing system; and
causing to be displayed in a main panel on a connected output device a graphical user interface showing the queried metrics data.
